(19) United States
(12) Patent Application Publication
(10) Pub. No.: US 2020/0393084 A1
(43) Pub. Date: Dec. 17, 2020

(54) APPARATUS AND METHODS FOR LUBRICANT FILTRATION AND DRUM PUMP FILTRATION SYSTEM

(71) Applicant: TRICO CORPORATION, Pewaukee, WI (US)

(72) Inventors: Adam Breidster, Waukesha, WI (US); Jay Wilson, Helenville, WI (US)

(73) Assignee: TRICO CORPORATION, Pewaukee, WI (US)

(21) Appl. No.: 16/441,479

(22) Filed: Jun. 14, 2019

(51) Int. Cl. F16N 39/06; F16N 19/00; F16N 5/00; B67D 7/04; B67D 7/08; B67D 7/62; B67D 7/76

(52) U.S. Cl. CPC F16N 39/06; F16N 19/00; F16N 5/00; B67D 7/04; F16N 2270/50; B67D 7/62; B67D 7/76; F16N 2250/06; B67D 7/08

(57) ABSTRACT

A lubricant filtration assembly is provided for quick attachment with a lubricant reservoir, for pre-filtering lubricant and pumping the lubricant to its intended destination.

### BACKGROUND OF THE INVENTION

Lubrication is an important aspect of maintaining machinery in proper operating condition. Machine elements such as bearings, journals, shafts, and joints require proper lubrication between their moving surfaces to decrease friction, prevent contamination, reduce wear and dissipate heat. Improper lubrication is likely to lead to premature component wear and component or system failure.

When determining the optimal lubrication between moving machine elements, many factors should be considered. These factors include the mode of operation of the machine, the type of machine element to be lubricated, the environment of the machine, the operating speed of the machine, the lubricant's viscosity, the lubricant's temperature, the lubricant's ingredients, and the lubricant's condition.

It is particularly desirable to provide lubricant delivery to a machine element relatively free of sediment, debris, or other foreign material that could have damaging effects on the machine element.

### SUMMARY OF THE INVENTION

The present invention provides an oil filter for filtering oil after being pumped from a reservoir, such as a 55-gallon drum. The oil filter can be coupled to the outside of the drum and coupled to a drum pump, without the necessity of a bracket being provided to couple the filter with a bung-engaging pathway for lubricant to be removed from the drum, filtered, and provided to the intended piece of machinery.

Lubricant stored in drums prior to use is not necessarily contaminant-free, and the present invention provides a filtration system to filter lubricant during removal from its storage container.

### BRIEF DESCRIPTION OF THE DRAWINGS

FIG. 1 is a perspective view of a lubricant filtration system of the present invention;

FIG. 2 is an exploded view of a lubricant filtration system of the present invention;

FIG. 3 is an overhead perspective view of components or a lubricant filtration system of the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

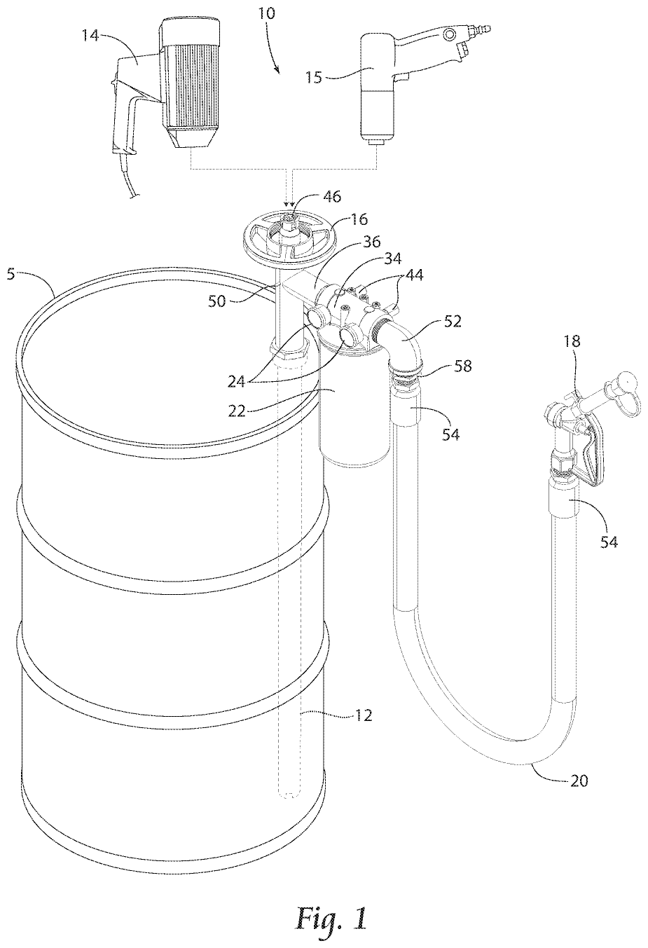

Referring now to FIG. 1, a perspective view of a lubricant filtration system 10 of the present invention is shown. The lubricant filtration system 10 is used to remove lubricant from drum 5, filter the lubricant with filter 22, and dispense the lubricant through dispensing handle 18.

One aspect of the invention is that the lubricant filtration system 10 can be removed from drums 5 and replaced onto new drums. Ordinarily it has been thought by end users that lubricant stored in drums prior to use is contaminant-free. However, it is now been learned that it is beneficial to filter lubricant even prior to its use by filtering the lubricant from its original container, as the original container can impart flIpurities to the lubricant prior to its first use.

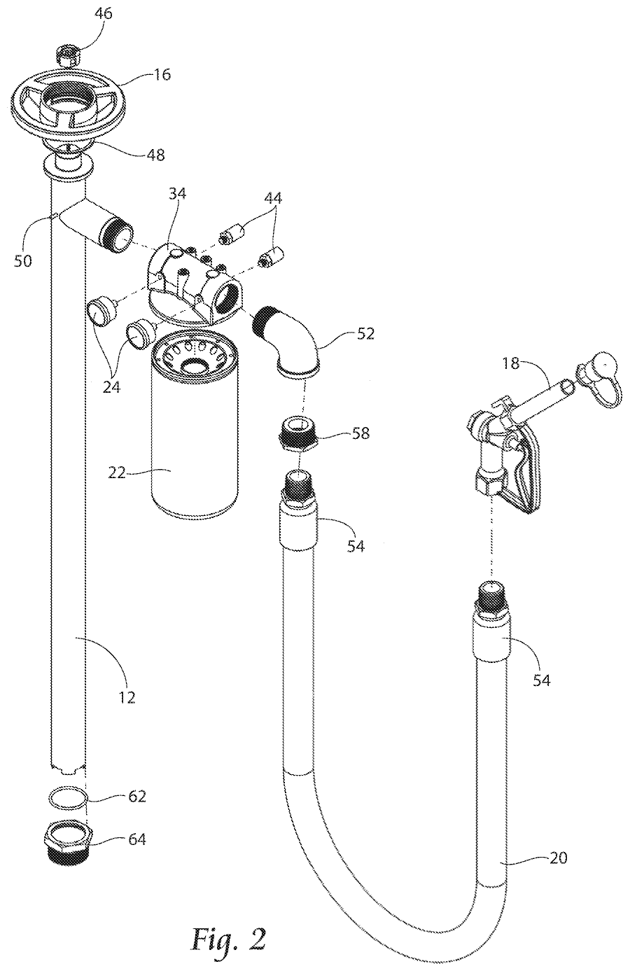

Lubricant intake 12 is coupled to the drum 5 at an opening, and through which lubricant is removed from drum 5 by either an electrical pump 14, preferably a centrifugally operated pump, by pneumatic unit 15 if air driven pumps are available, or any other type of pumping mechanism. A motor comprising electric pump 14 or pneumatic unit 14 turn shaft 12. Lubricant intake 12 is coupled externally to the drum 5 with a hand wheel 16, which has a threaded coupling for allowing easily the switching of different types of pumps, for instance electrical unit 14 can be unthreaded and switched with a pneumatic unit 15. O-ring 62 and bung adapter 64 are provided for coupling pipe 12 with drum 5 (shown on FIG. 2).

From the lubricant intake 12, the lubricant is withdrawn from the drum 5 and transferred via pipe 36 into filter unit 22 and filter head 34. Lubricant is forced through filter unit 22 into discharge pipe 20, ultimately to hand dispenser 18 so that the filtered lubricant can be dispensed.

Two front facing pressure gauges 24 are provided at the upstream and downstream of filter unit 22.

In a preferred embodiment, filter element(s) 22 are coupled directly to a drum pump 14 as a direct means of filtration. Although motor driven drum pumps 14 are shown, any pump type, such as piston pumps, or direct motor driven pumps could be employed.

Departing the filter unit 22, an elbow 52 carries a bushing 58, coupled to an additional swivel 54 and then dispensing line 20 leads to an additional swivel 54 for carrying dispensing unit 18.

Departing the filter unit 22, an elbow 52 carries a bushing swivel 54, coupled to an additional swivel 54 and then dispensing line 20 leads to an additional swivel 54, prior to an adapter 56 (preferably carried after elbow)for carrying dispensing unit 18.

Referring now to FIG. 2, an exploded view of a lubricant filtration system 10 of the present invention is shown. Preferably filter unit 22 is easily detachable to a filter head 34 so that changing filter units 22 after contamination can be easily accomplished.

The shaft 12 carries hand wheel 16 and pump coupling 46 and uses hand wheel retaining ring adapter 48 to fit into drum 5. Filter head 34 can receive threaded or other easily detachable couplings from. both the adapter 36 coupled to the lubricant intake 12 at the upstream of filter unit 22, and the dispensing line 20 coupled to the dispensing unit 18.

Gauges 24, preferably front facing, are provided at fluidically upstream and downstream positions of filter unit 22 so that a pressure differential can be detected, indicating a deterioration of the filter unit 22, possibly necessitating a change of filter units 22 for filtration efficacy. Sampling ports 44 are also provided upstream and downstream of the filter unit 22.

Carried by filter head 34, elbow 52 is coupled to bushing 58 and first swivel 54 carried by dispensing line 20, followed by second swivel 54.

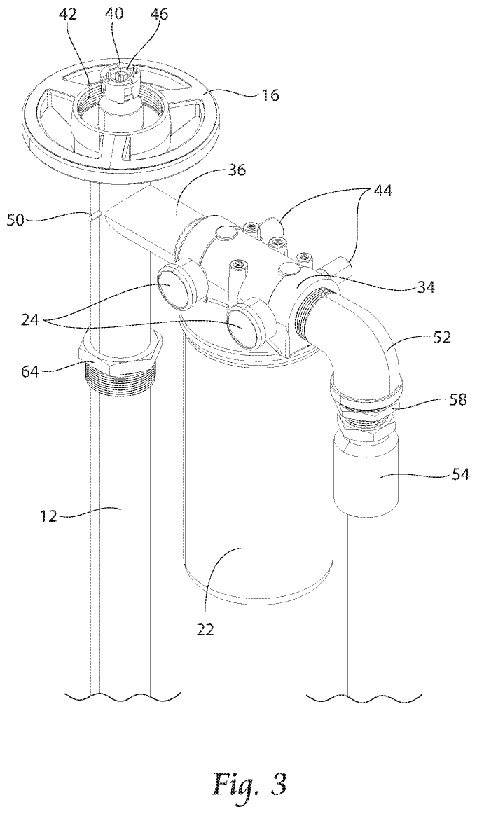

Referring now to FIG. 3, an overhead perspective view of components of the lubricant filtration system 10 of the present invention is shown. Hand wheel 16 is preferably provided with a threaded portion 42 for easily placing either electrical pump 14, a pneumatic unit 15, or any other type of pumping mechanism quickly and conveniently into communication through intake opening 40 through lubricant intake 12 into the drum 5 and associated lubricant.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A lubricant filtration system comprising:
a lubricant intake configured for immersing in lubricant and coupling to a reservoir containing said lubricant;
a band wheel structure coupled to said lubricant intake;
a pump for withdrawing said lubricant from said reservoir and transmitting said lubricant through said filtration system, said pump removably coupled to said hand wheel structure, and said pump selectively directing lubricant from said reservoir to a filter unit containing media;
a filter head coupled to said lubricant intake, said filter bead comprising a top, a bottom, a front side and a rear side, said filter head carrying a coupling for detachably carrying said filter unit containing said filter media;
said front side of said filter head carrying a pressure gauge for monitoring fluid pressure prior to lubricant entering said filter media, and a pressure gauge for monitoring fluid pressure after lubricant leaves said filter media, wherein each of said pressure gauge is connected directly to said filter head with no bracket between said pressure gauges and said filter head;
a discharge pipe coupled to said filter head;
a dispenser coupled to said discharge pipe, said dispenser for dispensing filtered lubricant;
a swivel hose attachment coupled to at least one of said discharge pipe and said dispenser;
said rear side of said filter head carrying a first sampling port between said reservoir and said filter media, and carrying a second sampling port between said filter media and said dispenser;
said filter head and said lubricant intake coupled together without a bracket.

2-4. (canceled)
